(19) United States
(12) Patent Application Publication
(10) Pub. No.: US 2009/0102819 A1
(43) Pub. Date: Apr. 23, 2009

(54) PLASMA DISPLAY APPARATUS

(76) Inventor: Yoonseok KWAK, Gumi-city (KR)

Correspondence Address: KED & ASSOCIATES, LLP, P.O. Box 221200, Chantilly, VA, 20153-1200, US

(21) Appl. No.: 12/109,833

(22) Filed: Apr. 25, 2008

(30) Foreign Application Priority Data
Oct. 19, 2007 (KR) 10-2007-0105406

(51) Int. Cl. G06F 3/038; G09G 3/28; H01J 1/63

(52) U.S. Cl. 345/204; 345/60; 313/486

(57) ABSTRACT

A plasma display apparatus is disclosed. The plasma display apparatus includes a plasma display panel and a driver. The plasma display panel includes a front substrate including a scan electrode and a sustain electrode, a rear substrate opposite to the front substrate, and a phosphor layer that is positioned between the front and rear substrates and includes a phosphor material and Mgo material. The driver supplies a rest signal to the scan electrode during a reset period of at least one of a plurality of subfields of a frame, supplies a scan signal to the scan electrode during an address period following the reset period, and supplies a first signal having a polarity opposite a polarity of the scan signal to the scan electrode between the reset signal and the scan signal.

This application claims the benefit of Korean Patent Application No. 10-2007-0105406 filed on Oct. 19, 2007, which is hereby incorporated by reference.

### BACKGROUND

1. Field

An exemplary embodiment relates to a plasma display apparatus.

2. Description of the Background Art

A plasma display apparatus includes a plasma display panel.

The plasma display panel includes a phosphor layer inside discharge cells partitioned by barrier ribs and a plurality of electrodes.

When driving signals are applied to the electrodes of the plasma display panel, a discharge occurs inside the discharge cells. In other words, when the plasma display panel is discharged by applying the driving signals to the discharge cells, a discharge gas filled in the discharge cells generates vacuum ultraviolet rays, which thereby cause phosphors positioned between the barrier ribs to emit light, thus producing visible light. An image is displayed on the screen of the plasma display panel due to the visible light.

### SUMMARY

In one aspect, a plasma display apparatus comprises a plasma display panel including a front substrate on which a scan electrode and a sustain electrode are positioned substantially parallel to each other, a rear substrate positioned opposite the front substrate, and a phosphor layer positioned between the front substrate and the rear substrate, the phosphor layer including a phosphor material and an additive material, the additive material including at least one of magnesium oxide (Mgo), zinc oxide (ZnO), silicon oxide (SiO₂), titanium oxide (TiO₂), yttrium oxide (Y₂O₃), aluminum oxide (Al₂O₃), lanthanum oxide (La₂O₃), europium oxide (EuO), cobalt oxide, iron oxide, or CNT (carbon nano tube), and a driver that supplies a rest signal to the scan electrode during a reset period of at least one of a plurality of subfields of a frame, supplies a scan signal to the scan electrode during an address period following the reset period, and supplies a first signal having a polarity opposite a polarity of the scan signal to the scan electrode between the reset signal and the scan signal.

In another aspect, a plasma display apparatus comprises a plasma display panel including a front substrate on which a scan electrode and a sustain electrode are positioned substantially parallel to each other, a rear substrate positioned opposite the front substrate, and a phosphor layer positioned between the front substrate and the rear substrate, the phosphor layer including a phosphor material and Mgo material, and a driver that supplies a rest signal to the scan electrode during a reset period of at least one of a plurality of subfields of a frame, supplies a scan signal to the scan electrode during an address period following the reset period, and supplies a first signal having a polarity opposite a polarity of the scan signal to the scan electrode between the reset signal and the scan signal.

In still another aspect, a plasma display apparatus comprises a plasma display panel including a front substrate on which a scan electrode and a sustain electrode are positioned substantially parallel to each other, a rear substrate positioned opposite the front substrate, and a phosphor layer positioned between the front substrate and the rear substrate, the phosphor layer including a phosphor material and MgO material, and a driver that supplies a rest signal to the scan electrode during a reset period of at least one of a plurality of subfields of a frame, and supplies a scan signal to the scan electrode during an address period following the reset period, wherein a voltage level of the scan electrode is higher than a voltage level of the sustain electrode between the reset signal and the scan signal.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 shows a configuration of a plasma display apparatus according to an exemplary embodiment;

FIG. 2 shows a structure of a plasma display panel according to the exemplary embodiment;

FIG. 3 shows a frame for achieving a gray scale of an image in the plasma display apparatus;

FIG. 4 illustrates an example of an operation of the plasma display apparatus;

FIG. 5 is a diagram for explaining a first signal and a second signal;

FIG. 6 is a diagram for explaining a width of a first signal;

FIG. 7 is a diagram for explaining a third signal and a fourth signal;

FIG. 8 is a diagram for comparing a sustain signal with a first signal;

FIG. 9 shows another form of a first signal and a second signal;

FIG. 10 shows a phosphor layer;

FIG. 11 illustrates an example of a method of manufacturing a phosphor layer;

FIGS. 12 and 13 are diagrams for explaining an effect of an additive material;

FIG. 14 is a diagram for explaining a content of an additive material;

FIG. 15 shows another structure of a phosphor layer;

FIG. 16 illustrates an example of another method of manufacturing a phosphor layer; and

FIG. 17 is a diagram for explaining a method of selectively using an additive material.

### DETAILED DESCRIPTION

Reference will now be made in detail embodiments of the invention examples of which are illustrated in the accompanying drawings.

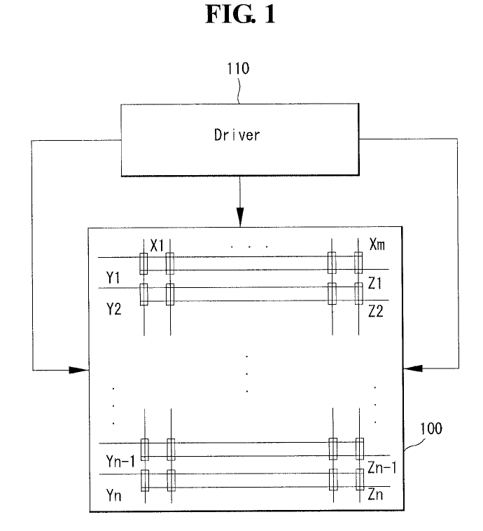

FIG. 1 shows a configuration of a plasma display apparatus according to an exemplary embodiment.

As shown in FIG. 1, the plasma display apparatus according to the exemplary embodiment includes a plasma display panel 100 and a driver 110.

The plasma display panel 100 includes scan electrodes Y1-Yn and sustain electrodes Z1-Zn positioned parallel to each other, and address electrodes X1-Xm positioned to intersect the scan electrodes Y1-Yn and the sustain electrodes Z1-Zn.

The driver 110 supplies a driving signal to at least one of the scan electrode, the sustain electrode, or the address electrode to display thereby an image on the screen of the plasma display panel 100.

Although FIG. 1 has shown the case that the driver 110 is formed in the form of a signal board, the driver 110 may be formed in the form of a plurality of boards depending on the electrodes formed in the plasma display panel 100. For example, the driver 110 may include a first driver (not shown) for driving the scan electrodes Y1-Yn, a second driver (not shown) for driving the sustain electrodes Z1-Zn, and a third driver (not shown) for driving the address electrodes X1-Xm.

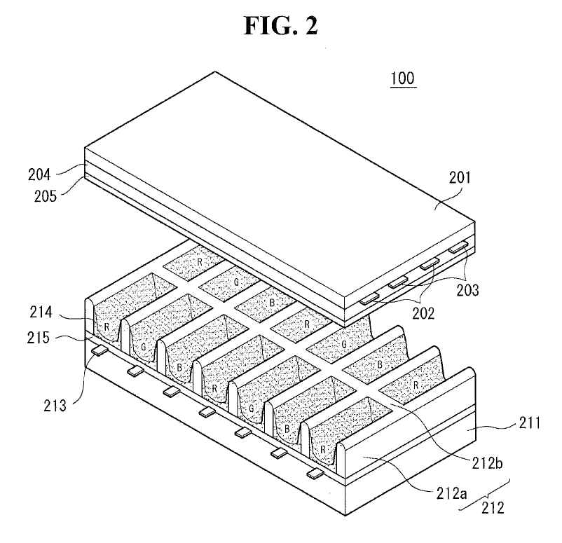

FIG. 2 shows a structure of a plasma display panel according to the exemplary embodiment.

As shown in FIG. 2, the plasma display panel 100 according to the exemplary embodiment may include a front substrate 201, on which a scan electrode 202 and a sustain electrode 203 are positioned parallel to each other, and a rear substrate 211 on which an address electrode 213 is positioned to intersect the scan electrode 202 and the sustain electrode 203.

An upper dielectric layer 204 may be positioned on the scan electrode 202 and the sustain electrode 203 to limit a discharge current of the scan electrode 202 and the sustain electrode 203 and to provide electrical insulation between the scan electrode 202 and the sustain electrode 203.

A protective layer 205 may be positioned on the upper dielectric layer 204 to facilitate discharge conditions. The protective layer 205 may include a material having a high secondary electron emission coefficient, for example, magnesium oxide (MgO).

A lower dielectric layer 215 may be positioned on the address electrode 213 to cover the address electrode 213 and to provide electrical insulation of the address electrodes 213.

Barrier ribs 212 of a stripe type, a well type, a delta type, a honeycomb type, and the like, may be positioned on the lower dielectric layer 215 to partition discharge spaces (i.e., discharge cells). Hence, a first discharge cell emitting red (R) light, a second discharge cell emitting blue (B) light, and a third discharge cell emitting green (G) light, and the like, may be positioned between the front substrate 201 and the rear substrate 211. In addition to the first, second, and third discharge cells, a fourth discharge cell emitting white (W) light or yellow (Y) light may be further positioned.

Widths of the first, second, and third discharge cells may be substantially equal to one another. Further, a width of at least one of the first, second, and third discharge cells may be different from widths of the other discharge cells. For instance, a width of the first discharge cell may be the smallest, and widths of the second and third discharge cells may be larger than the width of the first discharge cell. The width of the second discharge cell may be substantially equal to or different from the width of the third discharge cell. Hence, a color temperature of an image displayed on the plasma display panel 100 can be improved.

The plasma display panel 100 may have various forms of barrier rib structures as well as a structure of the barrier rib 212 shown in FIG. 2. For instance, the barrier rib 212 includes a first barrier rib 212b and a second barrier rib 212a. The barrier rib 212 may have a differential type barrier rib structure in which heights of the first and second barrier ribs 212b and 212a are different from each other, a channel type barrier rib structure in which a channel usable as an exhaust path is formed on at least one of the first barrier rib 212b or the second barrier rib 212a, a hollow type barrier rib structure in which a hollow is formed on at least one of the first barrier rib 212b or the second barrier rib 212a, and the like.

In the differential type barrier rib structure, a height of the first barrier rib 212b may be smaller than a height of the second barrier rib 212a. In the channel type barrier rib structure, a channel may be formed on the first barrier rib 212b.

While FIG. 2 has shown and described the case where the first, second, and third discharge cells are arranged on the same line, the first, second, and third discharge cells may be arranged in a different pattern. For instance, a delta type arrangement in which the first, second, and third discharge cells are arranged in a triangle shape may be applicable. Further, the discharge cells may have a variety of polygonal shapes such as pentagonal and hexagonal shapes as well as a rectangular shape.

Each of the discharge cells partitioned by the barrier ribs 212 may be filled with a discharge gas.

A phosphor layer 214 may be positioned inside the discharge cells to emit visible light for an image display during an address discharge. For instance, first, second, and third phosphor layers that produce red, blue, and green light, respectively, may be positioned inside the discharge cells. In addition to the first, second, and third phosphor layers, a fourth phosphor layer producing white and/or yellow light may be further positioned.

A thickness of at least one of the first, second, and third phosphor layers may be different from thicknesses of the other phosphor layers. For instance, a thickness of the second phosphor layer or the third phosphor layer may be larger than a thickness of the first phosphor layer. The thickness of the second phosphor layer may be substantially equal or different from the thickness of the third phosphor layer.

In FIG. 2, the upper dielectric layer 204 and the lower dielectric layer 215 each have a single-layered structure. However, at least one of the upper dielectric layer 204 or the lower dielectric layer 215 may have a multi-layered structure.

A black layer (not shown) capable of absorbing external light may be further positioned on the barrier rib 212 to prevent the external light from being reflected by the barrier rib 212. Further, another black layer (not shown) may be further positioned at a predetermined location of the front substrate 201 to correspond to the barrier rib 212.

While the address electrode 213 may have a substantially constant width or thickness, a width or thickness of the address electrode 213 inside the discharge cell may be different from a width or thickness of the address electrode 213 outside the discharge cell. For instance, a width or thickness of the address electrode 213 inside the discharge cell may be larger than a width or thickness of the address electrode 213 outside the discharge cell.

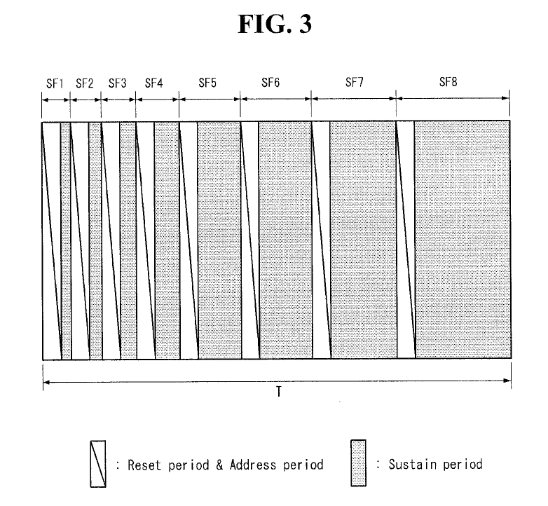

FIG. 3 shows a frame for achieving a gray scale of an image in the plasma display apparatus.

As shown in FIG. 3, a frame for achieving a gray scale of an image displayed by the plasma display apparatus according to the exemplary embodiment is divided into several subfields each having a different number of emission times.

Each subfield is subdivided into a reset period for initializing all the cells, an address period for selecting cells to be discharged, and a sustain period for representing gray level in accordance with the number of discharges.

For example, if an image with 256 gray levels is to be displayed, a frame, as shown in FIG. 3, is divided into 8 subfields SF1 to SF8. Each of the 8 subfields SF1 to SF8 is subdivided into a reset period, an address period, and a sustain period.

The number of sustain signals supplied during the sustain period determines a subfield weight of each subfield. For example, in such a method of setting a subfield weight of a first subfield SF1 at 2⁰ and a subfield weight of a second subfield at 2¹, a subfield weight of each subfield increases in a ratio of 2ⁿ (where, n=0, 1, 2, 3, 4, 5, 6, 7). Various images can be displayed by controlling the number of sustain signals supplied during a sustain period of each subfield depending on a subfield weight of each subfield.

Although FIG. 3 has shown and described the case where one frame includes 8 subfields, the number of subfields constituting one frame may vary. For example, one frame may include 10 subfields or 12 subfields.

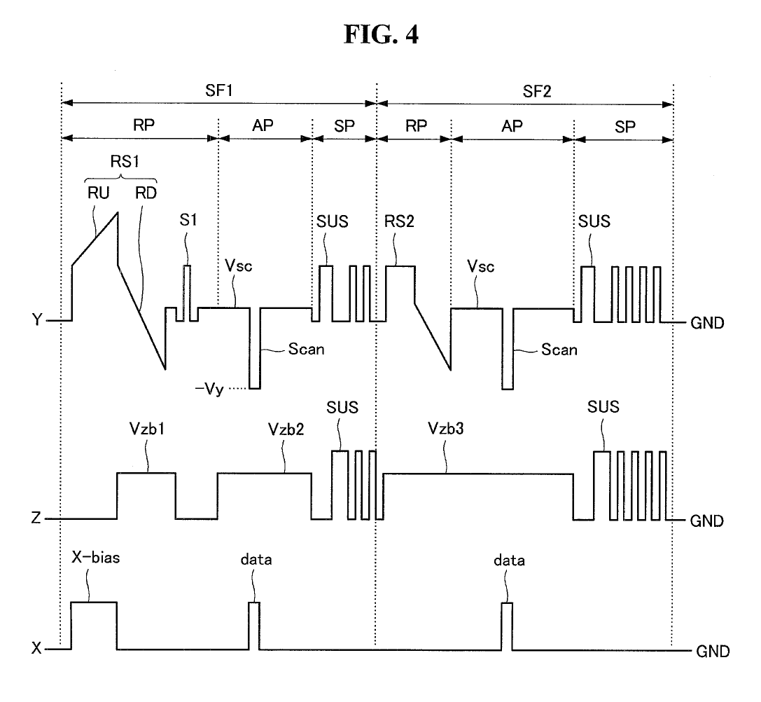

FIG. 4 illustrates an example of an operation of the plasma display apparatus.

As shown in FIG. 4, during a reset period RP for initialization of a first subfield SF1, a first reset signal RS1 may be supplied to the scan electrode Y. The first reset signal RS1 includes a rising signal RU and a falling signal RD.

The rising signal RU is supplied to the scan electrode Y, thereby generating a weak dark discharge (i.e., a setup discharge) inside the discharge cell. Hence, a proper amount of wall charges may be accumulated inside the discharge cell.

Then, the falling signal RD is supplied to the scan electrode Y, thereby generating a weak erase discharge (i.e., a set-down discharge) inside the discharge cell. Hence, the remaining wall charges are uniform inside the discharge cells to the extent that an address discharge occurs stably.

An address bias signal X-bias may be supplied to the address electrode X during the supply of the rising signal RU to the scan electrode Y, thereby reducing a voltage difference between the scan electrode Y and the address electrode X during the supply of the rising signal RU. Hence, the setup discharge can be prevented from occurring close to the address electrode X. Accordingly, the degradation of the phosphor layer and image sticking can be suppressed.

A first sustain bias signal Vzb1 may be supplied to the sustain electrode Z during the supply of the falling signal RD to the scan electrode Y, thereby stabilizing the set-down discharge.

During an address period AP following the reset period RP, a scan bias signal Vsc having a voltage level higher than a lowest voltage of the falling signal RD may be supplied to the scan electrode Y. A scan signal (Scan) falling from the scan bias signal Vsc may be supplied to the scan electrode Y.

A width of a scan signal supplied during an address period of at least one subfield may be different from widths of scan signals supplied during address periods of the other subfields. A width of a scan signal in a subfield may be larger than a width of a scan signal in a next subfield in time order. For instance, a width of the scan signal may be gradually reduced in the order of 2.6 μS, 2.3 μS, 2.1 μS, 1.9 μS, etc., or may be reduced in the order of 2.6 μS, 2.3 μs, 2.3 μS, 2.1 μS, . . . , 1.9 μS, 1.9 μS, etc, in the successively arranged subfields.

When the scan signal (Scan) is supplied to the scan electrode Y, a data signal (data) corresponding to the scan signal (Scan) may be supplied to the address electrode X.

As the voltage difference between the scan signal (Scan) and the data signal (data) is added to the wall voltage produced during the reset period RP, the address discharge occurs inside the discharge cell to which the data signal (data) is supplied.

A second sustain bias signal Vzb2 may be supplied to the sustain electrode Z during the address period AP so as to prevent the address discharge from unstably occurring by interference of the sustain electrode Z.

A voltage level of the second sustain bias signal vzb2 may be substantially equal to a voltage level of the first sustain bias signal Vzb1. A voltage magnitude of the first and second sustain bias signals Vzb1 and Vzb2 may be smaller than a voltage magnitude of a sustain signal (SUS) supplied to at least one of the scan electrode Y or the sustain electrode Z.

During a sustain period SP following the address period AP, the sustain signal (Sus) may be supplied to at least one of the scan electrode Y or the sustain electrode Z. For instance, the sustain signal (Sus) may be alternately supplied to the scan electrode Y and the sustain electrode Z.

As the wall voltage inside the discharge cell selected by performing the address discharge is added to a sustain voltage Vs of the sustain signal (Sus), every time the sustain signal (Sus) is supplied, a sustain discharge, i.e., a display discharge occurs between the scan electrode Y and the sustain electrode Z. A plurality of sustain signals are supplied during a sustain period of at least one subfield, and a width of at least one of the plurality of sustain signals may be different from widths of the other sustain signals. For instance, a width of a first supplied sustain signal among the plurality of sustain signals may be larger than widths of the other sustain signals. Hence, a sustain discharge can more stably occur.

It may be advantageous that a voltage level of the scan electrode Y is higher than a voltage level of the sustain electrode Z between the reset period RP and the address period AP (i.e., between the first reset signal RS1 and the scan signal (Scan)). For this, a first signal S1 having a polarity opposite a polarity of the scan signal (Scan) may be supplied to the scan electrode Y between the first reset signal RS1 and the scan signal (Scan), thereby more uniformly erasing wall charge inside the discharge cells after the reset period. Hence, an erroneous discharge can be prevented.

For instance, it is assumed that a scan signal and a data signal are supplied to a first discharge cell and a data signal is not supplied to a second discharge cell.

If an energy of wall charges inside the discharge cell increases due to a rise in a temperature of the plasma display panel to thereby lower a firing voltage, the intensity of setup and set-down discharges generated during a reset period in the first and second discharge cells may further increase. Hence, an excessive amount of wall charges may remain after a reset period.

An address discharge may occur in the first discharge to which the data signal is supplied and the second discharge cell to which the data signal is not supplied. That is, an erroneous discharge may occur due to the excessive amount of wall charges, thereby worsening the image quality.

In case that the first signal S1 is supplied to the scan electrode Y between the first reset signal RS1 and the scan signal (Scan), a weak erase discharge may occur between the reset signal RS1 and the scan signal (Scan). Hence, before the supply of the scan signal, the excessive amount of wall charges can be erased and the erroneous discharge can be prevented.

During a reset period RP of a second subfield SF2 following the first subfield SF1, a second reset signal RS2 may be supplied to the scan electrode Y.

The second reset signal RS2 does not include a rising signal as compared with the first reset signal RS1 of the first subfield SF1. In other words, because the rising signal RU and the first signal S1 stabilize the distribution of the wall charges in the first subfield SF1, a stable reset operation can be performed even if a voltage magnitude of the second reset signal RS2 is relatively small.

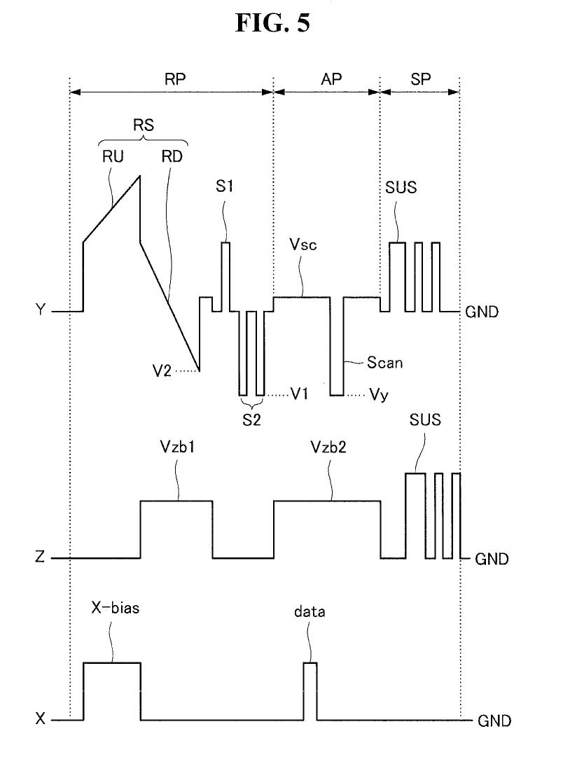

FIG. 5 is a diagram for explaining a first signal and a second signal.

As shown in FIG. 5, a first signal S1 and a second signal S2 having a polarity opposite a polarity of the first signal S1 may be supplied to the scan electrode Y between a reset signal RS and a scan signal (Scan). The supply of the second signal S2 may succeed the supply of the first signal S1. Further, the plurality of second signals S2 may be supplied.

As above, when the first signal S1 and the second signal S2 are supplied to the scan electrode Y, wall charges inside the discharge cells can be uniformly erased and an erroneous discharge can further prevented.

A lowest voltage V1 of the second signal S2 may be substantially equal to a lowest voltage −Vy of the scan signal (Scan). Hence, because the second signal S2 and the scan signal (Scan) can be produced using one voltage source, the manufacturing cost can be reduced. Further, the lowest voltage V1 of the second signal S2 may be lower than a lowest voltage V2 of a falling signal RD. Hence, the intensity of address discharge can be improved, and an addressing operation can be stabilized.

Further, a width of the second signal S2 may be substantially equal to a width of the first signal S1.

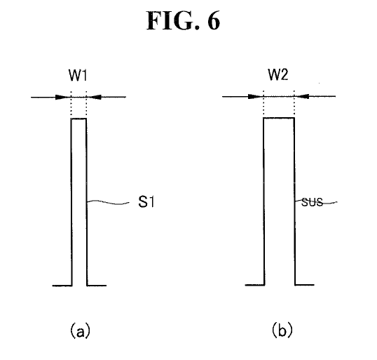

FIG. 6 is a diagram for explaining a width of a first signal.

As shown in FIG. 6, a width of the first signal S1 may be W1 in (a), and a width of the sustain signal (SUS) may be W2 in (b).

If the width W1 of the first signal S1 is larger than the width W2 of the sustain signal (SUS), the amount of wall charges erased by a discharge generated by the first signal S1 may be excessively small or the amount of wall charges after the discharge may even increase. Therefore, it is advantageous that the width W1 of the first signal S1 is smaller than the width W2 of the sustain signal (SUS).

Although it is not shown, it may be advantageous that a width of the second signal S2 is smaller than the width W2 of the sustain signal (SUS).

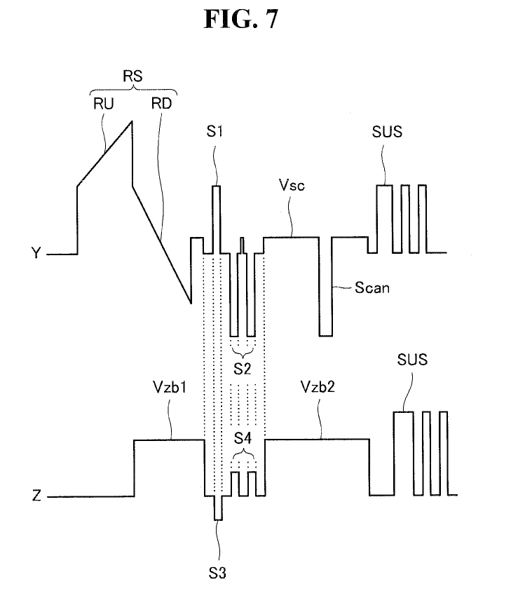

FIG. 7 is a diagram for explaining a third signal and a fourth signal.

As shown in FIG. 7, a third signal S3 and a fourth signal S4 may be supplied to the sustain electrode Z. The third signal S3 corresponds to the first signal S1 and has a polarity opposite a polarity of the first signal S1, and the fourth signal S4 corresponds to the second signal S2 and has a polarity opposite a polarity of the second signal S2.

As above, when the third signal S3 or the fourth signal S4 is supplied, the wall charges inside the discharge cells can be further uniformly erased. Hence, the erroneous discharge can be more effectively prevented.

A voltage magnitude of the third signal S3 may be smaller than a voltage magnitude of the first signal S1, and a voltage magnitude of the fourth signal S4 may be smaller than a voltage magnitude of the second signal S2.

The voltage magnitudes of the third and fourth signals S3 and S4 may be smaller than a voltage magnitude of the first or second sustain bias signal Vzb1 or Vzb2.

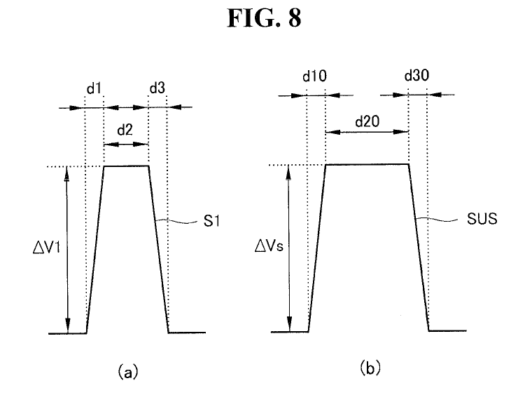

FIG. 8 is a diagram for comparing a sustain signal with a first signal.

As shown in FIG. 8, a voltage magnitude ΔV1 of the first signal S1 in (a) may be substantially equal to a voltage magnitude ΔVs of the sustain signal (SUS) in (b).

In (b) of FIG. 8, the sustain signal (SUS) may include a voltage rising period d10 during which a voltage of the sustain signal (SUS) gradually rises, a voltage maintaining period d20 during which a voltage of the sustain signal (SUS) is maintained at a highest voltage level, and a voltage falling period d30 during which a voltage of the sustain signal (SUS) gradually falls.

In (a) of FIG. 8, the first signal S1 may include a voltage rising period d1, a voltage maintaining period d2, and a voltage falling period d3. A rate of voltage change over time (that is, a slope) during the voltage rising period d1 of the first signal S1 may be substantially equal to a rate of voltage change over time (that is, a slope) during the voltage rising period d10 of the sustain signal (SUS). A rate of voltage change over time during the voltage falling period d3 of the first signal S1 may be substantially equal to a rate of voltage change over time during the voltage falling period d30 of the sustain signal (SUS).

As above, because the rate of voltage change over time during each of the voltage rising and falling periods d1 and d3 is substantially equal to the rate of voltage change over time during each of the voltage rising and falling periods d10 and d30, and the voltage magnitude ΔV1 of the first signal S1 is substantially equal to the voltage magnitude ΔVs of the sustain signal (SUS), the first signal S1 and the sustain signal (SUS) can be produced using one energy recovery circuit. Hence, the manufacturing cost can be reduced.

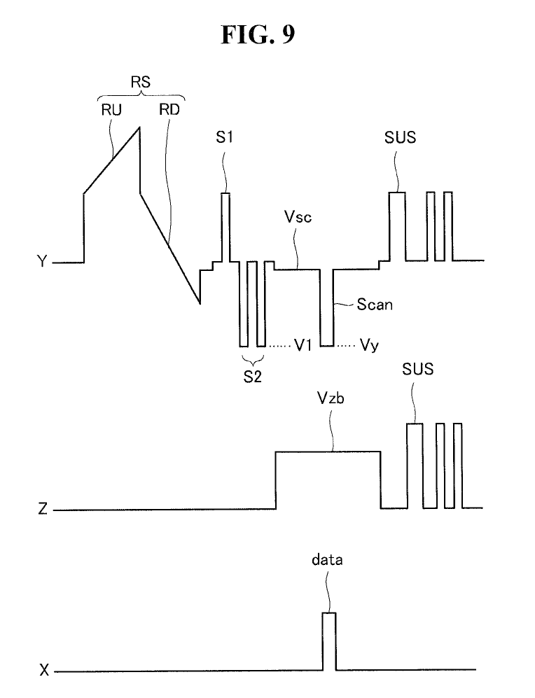

FIG. 9 shows another form of a first signal and a second signal.

As shown in FIG. 9, a voltage level of the scan bias signal Vsc supplied to the scan electrode Y during the address period may be lower than the ground level voltage GND.

In this case, it is possible that the voltage magnitude ΔV1 of the first signal S1 is substantially equal to the voltage magnitude ΔVs of the sustain signal (SUS), and the lowest voltage V1 of the second signal S2 is substantially equal to the lowest voltage −Vy of the sustain signal (SUS).

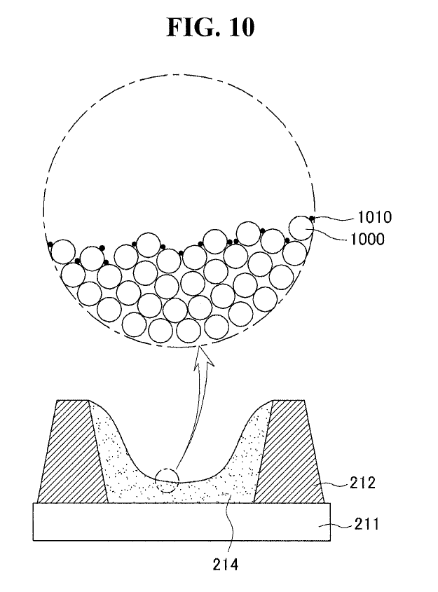

FIG. 10 shows a phosphor layer.

As shown in FIG. 10, the phosphor layer 214 includes particles 1000 of a phosphor material and particles 1010 of an additive material.

The particles 1010 of the additive material can improve a discharge response characteristic between the scan electrode and the address electrode or between the sustain electrode and the address electrode. This will be below described in detail.

When a scan signal is supplied to the scan electrode and a data signal is supplied to the address electrode, charges may be accumulated on the surface of the particles 1000 of the phosphor material.

If the phosphor layer 214 does not include an additive material, charges may be concentratedly accumulated on a specific portion of the phosphor layer 214 because of the nonuniform height of the phosphor layer 214 and the nonuniform distribution of the particles of the phosphor material. Hence, a relatively strong discharge may occur in the specific portion of the phosphor layer 214 on which charges are concentratedly accumulated.

Further, charges may be concentratedly accumulated in a different area of each discharge cell, and thus a discharge may occur unstably and nonuniformly. In this case, the image quality of a displayed image may worsen, and thus a viewer may watch a noise such as spots.

On the other hand, in case that the phosphor layer 214 includes the additive material such as MgO as in the exemplary embodiment, the additive material acts as a catalyst of a discharge. Hence, a discharge can stably occur between the scan electrode and the address electrode at a relatively low voltage. Accordingly, before the strong discharge occurs at a relatively high voltage in the specific portion of the phosphor layer 214, on which charges are concentratedly accumulated, a discharge can occur at a relatively low voltage in a portion of the phosphor layer 214, on which the particles of the additive material are positioned. Hence, discharge characteristics of each discharge cell can be uniform. This is caused by a reason why the additive material has a high secondary electron emission coefficient.

The additive material is not limited particularly except the improvement of the discharge response characteristic between the scan electrode and the address electrode or between the sustain electrode and the address electrode. Examples of the additive material include at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), europium oxide (EuO), cobalt oxide, iron oxide, or CNT (carbon nano tube). It may be advantageous that the additive material is MgO.

At least one of the particles 1000 of the phosphor material on the surface of the phosphor layer 214 may be exposed in a direction toward the center of the discharge cell. For instance, since the particles 1010 of the additive material are disposed between the particles 1000 of the phosphor material on the surface of the phosphor layer 214, at least one particle 1000 of the phosphor material may be exposed.

As described above, when the particles 1010 of the additive material are disposed between the particles 1000 of the phosphor material, a discharge response characteristic between the scan electrode and the address electrode or between the sustain electrode and the address electrode can be improved. Further, since the surface area of the particles 1000 of the phosphor material covered by the particles 1010 of the additive material may be minimized, an excessive reduction in a luminance can be prevented.

Although it is not shown, if the particles 1010 of the additive material are uniformly coated on the surface of the phosphor layer 214, and a layer formed of the additive material is formed on the surface of the phosphor layer 214, the additive layer covers the most of the surface of the particles 1000 of the phosphor material. Hence, a luminance may be excessively reduced.

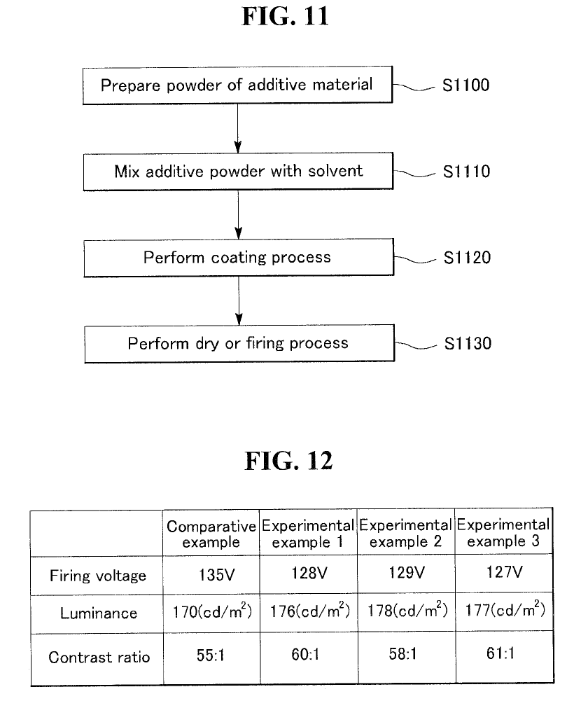

FIG. 11 illustrates an example of a method of manufacturing a phosphor layer.

As shown in FIG. 11, first, a powder of an additive material is prepared in step S100. For instance, a gas oxidation process is performed on Mg vapor generated by heating Mg to form a powder of MgO.

Next, the prepared additive power is mixed with a solvent in step S1110. For instance, the resulting MgO powder is mixed with methanol to manufacture an additive paste or an additive slurry. A binder may be added so as to adjust a viscosity of the additive paste or the additive slurry.

Subsequently, the additive paste or slurry is coated on the phosphor layer in step S1120. In this case, a viscosity of the additive paste or the additive slurry is adjusted so that the particles of the additive material are smoothly positioned between the particles of the phosphor material.

Subsequently, a dry process or a firing process is performed in step S1130. Hence, the solvent mixed with the additive material is evaporated to form the phosphor layer of FIG. 10.

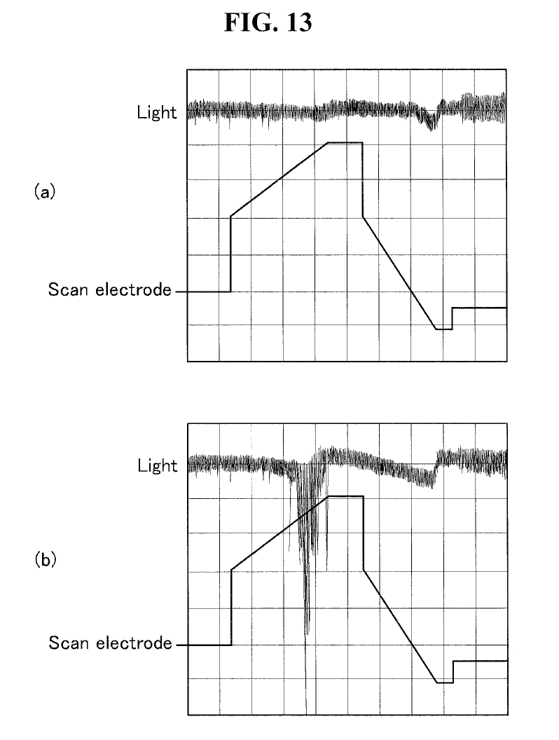

FIGS. 12 and 13 are diagrams for explaining an effect of an additive material.

FIG. 12 is a table showing a firing voltage, a luminance of a displayed image, and a bright room contrast ratio of each of a comparative example and experimental examples 1, 2 and 3. The bright room contrast ratio measures a contrast ratio in a state where an image with a window pattern occupying 45% of the screen size is displayed in a bright room. The firing voltage is a firing voltage measured between the scan electrode and the address electrode.

In the comparative example, the phosphor layer does not include an additive material.

In the experimental example 1, the phosphor layer includes MgO of 3% based on the volume of the phosphor layer as an additive material.

In the experimental example 2, the phosphor layer includes MgO of 9% based on the volume of the phosphor layer as an additive material.

In the experimental example 3, the phosphor layer includes MgO of 12% based on the volume of the phosphor layer as an additive material.

In the comparative example, the firing voltage is 135V, and the luminance is 170 cd/m².

In the experimental examples 1, 2 and 3, the firing voltage is 127V to 129V lower than the firing voltage of the comparative example, and the luminance is 176 cd/m² to 178 cd/m² higher than the luminance of the comparative example. Because the particles of the MgO material as the additive material in the experimental examples 1, 2 and 3 act as a catalyst of a discharge, the firing voltage between the scan electrode and the address electrode is lowered. Furthermore, in the experimental examples 1, 2 and 3, because an intensity of a discharge generated at the same voltage as the comparative example increases due to a fall in the firing voltage, the luminance further increases.

While the bright room contrast ratio of the comparative example is 55:1, the bright room contrast ratio of the experimental examples 1, 2 and 3 is 58:1 to 61:1. As can be seen from FIG. 12, a contrast characteristic of the experimental examples 1, 2 and 3 is more excellent than that of the comparative example.

In the experimental examples 1, 2 and 3, a uniform discharge occurs at a lower firing voltage than that of the comparative example, and thus the quantity of light during a reset period is relatively small in the experimental examples 1, 2 and 3.

In FIG. 13, (a) is a graph showing the quantity of light in the experimental examples 1, 2 and 3, and (b) is a graph showing the quantity of light in the comparative example.

As shown in (b) of FIG. 13, because an instantaneously strong discharge occurs at a relatively high voltage in the comparative example not including the MgO material, the quantity of light may instantaneously increase. Hence, the contrast characteristics may worsen.

As shown in (a) of FIG. 13, because a discharge occurs at a relatively low voltage in the experimental examples 1, 2 and 3 including the MgO material, a weak reset discharge continuously occurs during a reset period. Hence, a small quantity of light is generated, and the contrast characteristics can be improved.

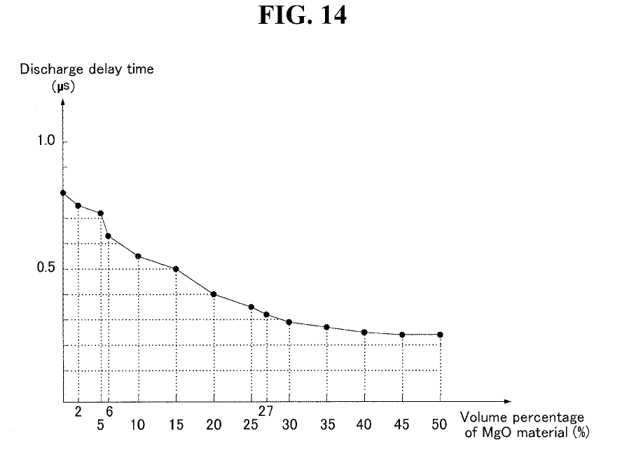

FIG. 14 is a graph measuring a discharge delay time of an address discharge while a percentage of a volume of Mgo material used as an additive material based on the volume of the phosphor layer changes from 0% to 50%.

The address discharge delay time means a time interval between a time when the scan signal and the data signal are supplied during an address period and a time when an address discharge occurs between the scan electrode and the address electrode.

As shown in FIG. 14, when the volume percentage of the Mgo material is 0 (in other words, when the phosphor layer does not include MgO material), the discharge delay time may be approximately 0.8 μS.

When the volume percentage of the MgO material is 2%, the discharge delay time is reduced to be approximately 0.75 μS. In other words, because the particles of the MgO material improve a discharge response characteristic between the scan electrode and the address electrode, an address jitter characteristic can be improved.

Further, when the volume percentage of the MgO material is 5%, the discharge delay time may be approximately 0.72 μS. When the volume percentage of the MgO material is 6%, the discharge delay time may be approximately 0.63 μS.

When the volume percentage of the MgO material lies in a range between 10% and 50%, the discharge delay time may be reduced from approximately 0.55 μS to 0.24 μS.

It can be seen from the graph of FIG. 14 that as a content of the MgO material increases, the discharge delay time can be reduced. Hence, the address jitter characteristic can be improved. However, an improvement width of the address jitter characteristic may gradually decrease. In case that the volume percentage of the MgO material is equal to or more than 40%, a reduction width of the discharge delay time may be small.

On the other hand, in case that the volume percentage of the MgO material is excessively large, the particles of the MgO material may excessively cover the surface of the particles of the phosphor material. Hence, a luminance may be reduced.

Accordingly, the percentage of the volume of the MgO material based on the volume of the phosphor layer may lie substantially in a range between 2% and 40% or between 6% and 27% so as to reduce the discharge delay time and to prevent an excessive reduction in the luminance.

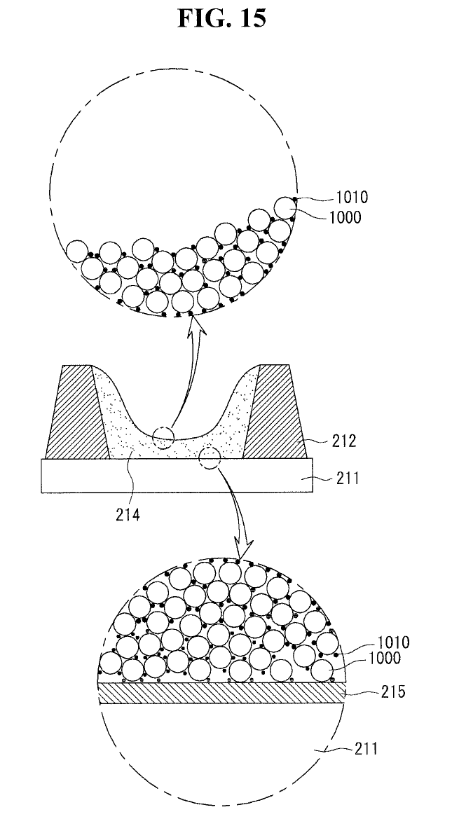

FIG. 15 shows another structure of a phosphor layer.

As shown in FIG. 15, the particles 1010 of the additive material may be positioned on the surface of the phosphor layer 214, inside the phosphor layer 214, and between the phosphor layer 214 and the lower dielectric layer 215.

When the particles 1010 of the additive material may be positioned on the surface of the phosphor layer 214, inside the phosphor layer 214, and between the phosphor layer 214 and the lower dielectric layer 215, a discharge response characteristic between the scan electrode and the address electrode or between the sustain electrode and the address electrode can be improved.

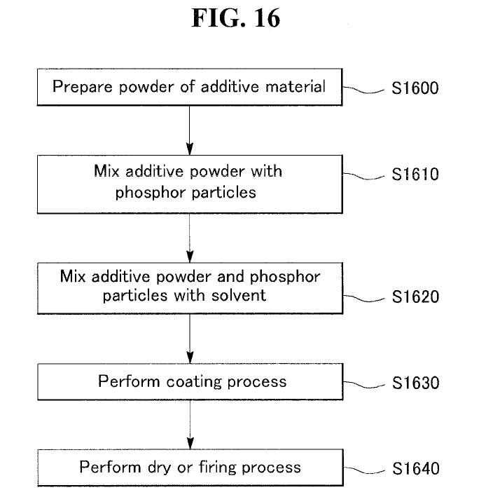

FIG. 16 illustrates an example of another method of manufacturing a phosphor layer.

As shown in FIG. 16, a powder of an additive material is prepared in step S1600.

The prepared additive power is mixed with phosphor particles in step S1610.

The additive power and the phosphor particles are mixed with a solvent in step S1620.

The additive power and the phosphor particles mixed with the solvent are coated inside the discharge cells in step S1630. In the coating process, a dispensing method may be used.

A dry process or a firing process is performed in step S1640 to evaporate the solvent. Hence, the phosphor layer having the structure shown in FIG. 15 is formed.

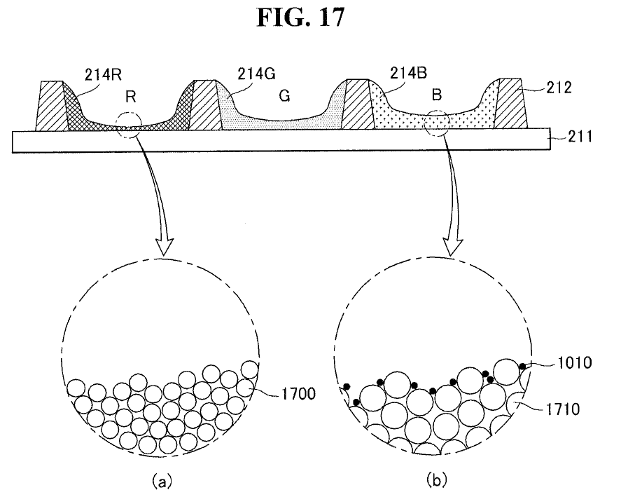

FIG. 17 is a diagram for explaining a method of selectively using an additive material.

As shown in FIG. 17, the phosphor layer includes a first phosphor layer 214R emitting red light, a second phosphor layer 214B emitting blue light, and a third phosphor layer 214G emitting green light. At least one of the first phosphor layer 214R, the second phosphor layer 214B, or the third phosphor layer 214G may not include the additive material.

For instance, as shown in (a), the first phosphor layer 214R includes particles 1700 of a first phosphor material, but does not include an additive material. As shown in (b), the second phosphor layer 214B includes particles 1710 of a second phosphor material and particles 1010 of an additive material. In this case, the quantity of light generated in the second phosphor layer 214B can increase, and thus a color temperature can be improved.

The size of the particles 1710 of the second phosphor material in (b) may be larger than the size of the particles 1700 of the first phosphor material in (a). In this case, a discharge in the second phosphor layer 214B in (b) may be more unstable than a discharge in the first phosphor layer 214R in (a). However, because the second phosphor layer 214B includes the particles 1010 of the additive material, the discharge in the second phosphor layer 214B can be stabilized.

The particles of the MgO material included in the phosphor layer may have one orientation or two or more different orientations. For instance, only (200)-oriented MgO material may be used, or (200)- and (111)-oriented MgO material may be used. However, (200)-oriented MgO material and (111)-oriented MgO material may be together used so as to improve a discharge response characteristic between the scan electrode and the address electrode or between the sustain electrode and the address electrode and to prevent the degradation of the phosphor layer.

For instance, while the (111)-oriented Mgo material has a relatively higher secondary electron emission coefficient than the (200)-oriented MgO material, the (111)-oriented MgO material has a relatively weaker sputter resistance than the (200)-oriented MgO material. Further, wall charges accumulating characteristic of the (111)-oriented MgO material is weaker than that of the (200)-oriented MgO material.

Accordingly, in case that only the (111)-oriented MgO material is used, it is possible to improve a discharge response characteristic between the scan electrode and the address electrode or between the sustain electrode and the address electrode. However, it is difficult to prevent the degradation of the phosphor layer.

On the other hand, in case that only the (200)-oriented Mgo material is used, it is possible to prevent the degradation of the phosphor layer. However, it is difficult to improve a discharge response characteristic between the scan electrode and the address electrode or between the sustain electrode and the address electrode.

Accordingly, the (200)-oriented MgO material and the (111)-oriented MgO material may be together used so as to improve the discharge response characteristic between the scan electrode and the address electrode or between the sustain electrode and the address electrode and to prevent the degradation of the phosphor layer.

In case that the phosphor layer includes the MgO material, the amount of charges accumulated on the surface of the phosphor layer may increase. As a result, the degradation of the phosphor particles may be accelerated. Accordingly, a content of the (200)-oriented MgO material having the relatively stronger sputter resistance may be more than a content of the (111)-oriented MgO material, so as to prevent the degradation of the phosphor particles.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display apparatus comprising:
a plasma display panel including:
a front substrate on which a scan electrode and a sustain electrode are positioned substantially parallel to each other;
a rear substrate positioned opposite the front substrate; and
a phosphor layer positioned between the front substrate and the rear substrate, the phosphor layer including a phosphor material and an additive material, the additive material including at least one of magnesium oxide (MgO), zinc oxide (ZnO), silicon oxide (SiO₂), titanium oxide (TiO₂) yttrium oxide (Y₂O₃), aluminum oxide (Al₂O₃), lanthanum oxide (La₂O₃), europium oxide (EuO), cobalt oxide, iron oxide, or CNT (carbon nano tube); and
a driver that supplies a rest signal to the scan electrode during a reset period of at least one of a plurality of subfields of a frame, supplies a scan signal to the scan electrode during an address period following the reset period, and supplies a first signal having a polarity opposite a polarity of the scan signal to the scan electrode between the reset signal and the scan signal.

2. The plasma display apparatus of claim 1, wherein the driver supplies a second signal having a polarity opposite a polarity of the first signal to the scan electrode between the reset signal and the scan signal.

3. The plasma display apparatus of claim 2, wherein a lowest voltage level of the second signal is substantially equal to a lowest voltage level of the scan signal.

4. The plasma display apparatus of claim 2, wherein the reset signal includes a falling signal whose a voltage gradually falls, and a lowest voltage level of the second signal is lower than a lowest voltage level of the falling signal.

5. The plasma display apparatus of claim 1, wherein a voltage magnitude of the first signal is substantially equal to a voltage magnitude of a sustain signal supplied to at least one of the scan electrode or the sustain electrode during a sustain period following the address period.

6. The plasma display apparatus of claim 1, wherein a width of the first signal is smaller than a width of a sustain signal supplied to at least one of the scan electrode or the sustain electrode during a sustain period following the address period.

7. The plasma display apparatus of claim 1, wherein the additive material includes Mgo material, and
the MgO material includes (200)-oriented MgO material and (111)-oriented MgO material, and a content of the (111)-oriented MgO material is less than a content of (200)-oriented MgO material.

8. The plasma display apparatus of claim 1, wherein at least one of particles of the additive material is positioned on the surface of the phosphor layer.

9. The plasma display apparatus of claim 1, further comprising a lower dielectric layer between the phosphor layer and the rear substrate,
wherein at least one of particles of the additive material is positioned between the phosphor layer and the lower dielectric layer.

10. The plasma display apparatus of claim 1, wherein a percentage of a volume of the additive material based on a volume of the phosphor layer lies substantially in a range between 2% and 40%.

11. The plasma display apparatus of claim 1, wherein the phosphor layer includes a first phosphor layer emitting red light, a second phosphor layer emitting blue light, and a third phosphor layer emitting green light, and
the additive material is omitted in at least one of the first phosphor layer, the second phosphor layer, or the third phosphor layer.

12. A plasma display apparatus comprising:
a plasma display panel including:
a front substrate on which a scan electrode and a sustain electrode are positioned substantially parallel to each other;
a rear substrate positioned opposite the front substrate; and
a phosphor layer positioned between the front substrate and the rear substrate, the phosphor layer including a phosphor material and Mgo material; and
a driver that supplies a rest signal to the scan electrode during a reset period of at least one of a plurality of subfields of a frame, supplies a scan signal to the scan electrode during an address period following the reset period, and supplies a first signal having a polarity opposite a polarity of the scan signal to the scan electrode between the reset signal and the scan signal.

13. The plasma display apparatus of claim 12, wherein the driver supplies a second signal having a polarity opposite a polarity of the first signal to the scan electrode between the reset signal and the scan signal.

14. The plasma display apparatus of claim 13, wherein a lowest voltage level of the second signal is substantially equal to a lowest voltage level of the scan signal.

15. The plasma display apparatus of claim 13, wherein the reset signal includes a falling signal whose a voltage gradually falls, and a lowest voltage level of the second signal is lower than a lowest voltage level of the falling signal.

16. The plasma display apparatus of claim 12, wherein a voltage magnitude of the first signal is substantially equal to a voltage magnitude of a sustain signal supplied to at least one of the scan electrode or the sustain electrode during a sustain period following the address period.

17. The plasma display apparatus of claim 12, wherein a width of the first signal is smaller than a width of a sustain signal supplied to at least one of the scan electrode or the sustain electrode during a sustain period following the address period.

18. A plasma display apparatus comprising:
a plasma display panel including:
a front substrate on which a scan electrode and a sustain electrode are positioned substantially parallel to each other;
a rear substrate positioned opposite the front substrate; and
a phosphor layer positioned between the front substrate and the rear substrate, the phosphor layer including a phosphor material and MgO material; and
a driver that supplies a rest signal to the scan electrode during a reset period of at least one of a plurality of subfields of a frame, and supplies a scan signal to the scan electrode during an address period following the reset period,
wherein a voltage level of the scan electrode is higher than a voltage level of the sustain electrode between the reset signal and the scan signal.

19. The plasma display apparatus of claim 18, wherein the driver supplies a first signal having a polarity opposite a polarity of the scan signal to the scan electrode between the reset signal and the scan signal.

20. The plasma display apparatus of claim 19, wherein the driver supplies a second signal having a polarity opposite a polarity of the first signal to the scan electrode between the reset signal and the scan signal.
